(19) United States
(12) Patent Application Publication
(10) Pub. No.: US 2026/0268738 A1
(43) Pub. Date: Sep. 10, 2026

(54) GAMING MACHINE WITH SPECIAL-SYMBOL BANK FEATURE

(71) Applicant: LNW Gaming, Inc., Las Vegas, NV (US)

(72) Inventors: Jeffry L. NAUMAN, Yorkville, IL (US); Brett J. GRIMES, Chicago, IL (US)

(21) Appl. No.: 19/351,835

(22) Filed: Oct. 7, 2025

Related U.S. Application Data
(60) Provisional application No. 63/768,645, filed on Mar. 7, 2025.

(51) Int. Cl. G07F 17/32; G07F 17/34

(52) U.S. Cl. CPC G07F 17/3267; G07F 17/3211; G07F 17/34

(57) ABSTRACT

There is described a gaming system, gaming machine, method, etc. to perform operations which include presenting special-symbol banks that correspond, respectively, to different types of special symbols. The operations land, via reels and an array, a special-symbol activator that corresponds to a first type of the special symbols and which corresponds to a respective special-symbol bank. The operations can further include transferring to the array, from the respective special-symbol bank, additional special symbol(s) of the first type. The transferring selects, for placement of additional special symbol(s), an array cell that includes a second type of special symbol and not selecting any cell that already includes a special symbol of the first type. The operations further include animating, via the at least one cell of the array, content based on a number of special symbols in the array cell.

### CROSS-REFERENCE TO RELATED APPLICATION(S)

This patent application claims priority benefit of U.S. Provisional Patent Application No. 63/768,645 filed Mar. 7, 2025, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

FIELD

The present invention relates to a technological improvement to gaming systems, gaming machines, and methods thereon and, more particularly, to new and improved animations in connection with a secondary or bonus feature.

### BACKGROUND

The gaming industry depends upon player participation. Players are generally “hopeful” players who either think they are lucky or at least think they can get lucky-for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY

According to an embodiment of the present disclosure, there is provided a gaming system, gaming machine, method, etc. to perform operations (e.g., via game-logic circuitry). For example, the operations may include presenting, by a processor via a presentation assembly in response to generation of presentation data and storage of the data in a computer memory, a plurality of special-symbol banks. Each of the plurality of special-symbol banks corresponds to a different one of a plurality of types of special symbols. The operations can further include presenting a plurality of reels and an array, the plurality of reels bearing a plurality of symbols, the plurality of symbols including the plurality of types of special symbols, and a plurality of special-symbol activators. Each of the plurality of special-symbol activators corresponds to a different respective one of the plurality of types of special symbols. The operations can further include conducting, in response to a trigger event, a series of game cycles. In one example, conducting each of the series of game cycles includes spinning and stopping the plurality of reels to land one or more of the plurality of types of special symbols in the array and landing a first special-symbol activator associated with a first of the plurality of special-symbol banks. Furthermore, conducting each of the series of game cycles can further include transferring to the array, from the first of the plurality of special-symbol banks in response to the first special-symbol activator landing, one or more special symbols of a first type of the plurality of types of special symbols. The first type of the plurality of types of special symbols corresponds to the first special-symbol activator. The transferring to the array of the one or more special symbols of the first type includes selecting, for placement in the array, at least one cell of the array that already includes a second type of the plurality of types of special symbols and not selecting any cell of the array that already includes any special symbol of the first type. The operations can further include animation, via the at least one cell of the array, of content based on a number of special symbols in the at least one cell of the array.

In another embodiment of the present disclosure, there is provided a gaming system, gaming machine, method, etc. to perform operations that include presenting, by a presentation assembly of a gaming machine via generation of presentation data and storage of the data in a computer memory communicatively connected to the presentation assembly, a plurality of special-symbol banks. Each of the plurality of special-symbol banks corresponds to a respective one of a plurality of types of special symbols. The operations can further include presenting, via the presentation assembly, an array for a plurality of reels, the plurality of reels bearing a plurality of symbols, the plurality of symbols including standard symbols, a catalyst symbol, and the plurality of types of special symbols. The operations can further include spinning and stopping, via the presentation assembly, the plurality of reels to land, based on a random number generator, symbols from the plurality of symbols in the array. The operations can further include transferring to the array, via the presentation assembly in response to the array landing at least the catalyst symbol and a first special symbol of one of the plurality of types of special symbols, a second special symbol of the one of the plurality of types of special symbols from the one of the plurality of special-symbol banks that corresponds to the one of the plurality of types of special symbols. The operations can further include animating, via the presentation assembly in response to the transferring the second special symbol, a transformation of the first special symbol and the second special symbol via one of a plurality of transformation visual effects associated with the one of the plurality of types of special symbols.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present disclosure.

FIG. 2 is a block diagram of a gaming system according to an embodiment of the present disclosure.

FIG. 3 is a flow diagram for a data processing method that corresponds to instructions executed by game-logic circuitry, according to an embodiment of the present disclosure.

FIGS. 4-12 are an exemplary representation of a series of game cycle events and/or outcomes (i.e., spin outcomes) for a game feature according to an embodiment of the present disclosure.

FIG. 13 is a diagram of an example gaming system according to an embodiment of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

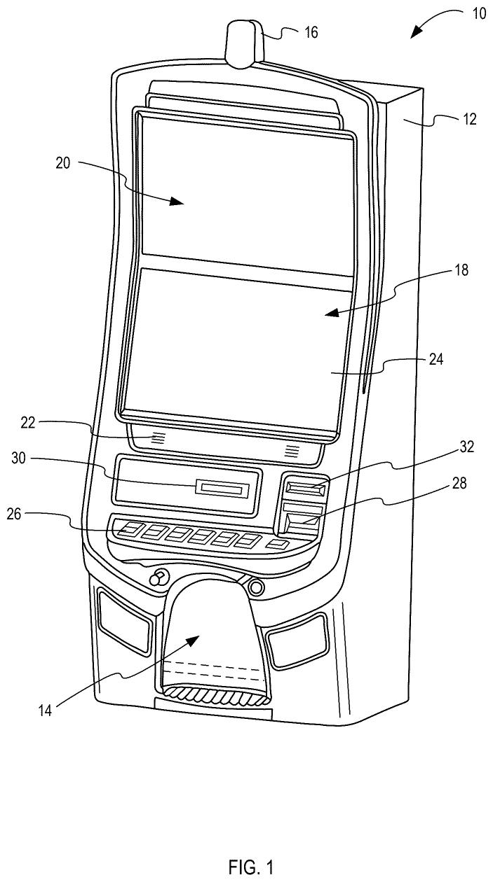

Referring to FIG. 1, there is shown a gaming machine 10 similar to those operated in gaming establishments, such as casinos. With regard to the present disclosure, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

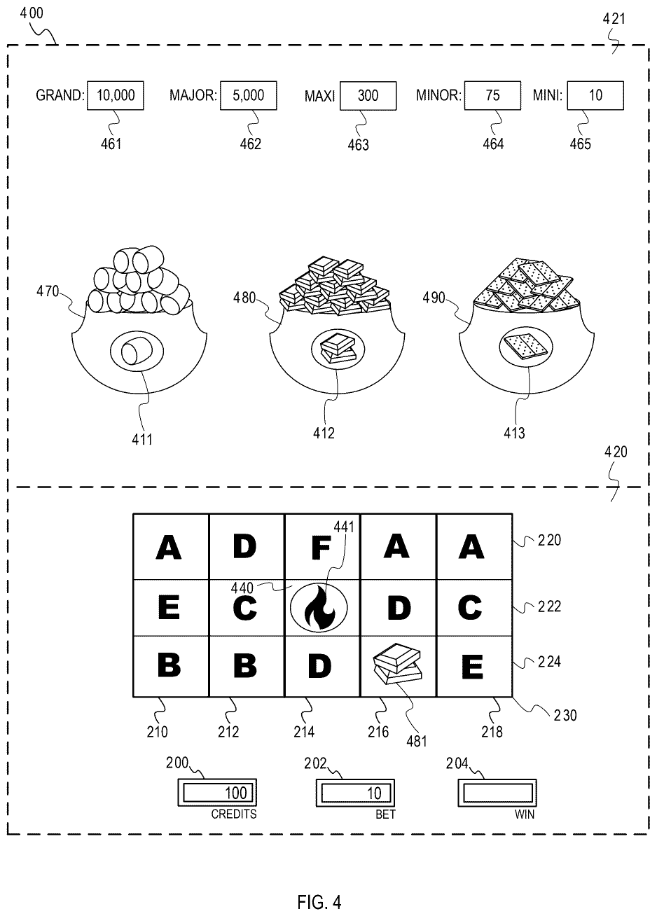

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIGS. 4-12). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the credits meter (e.g., credit meter 200, see FIGS. 4-12), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

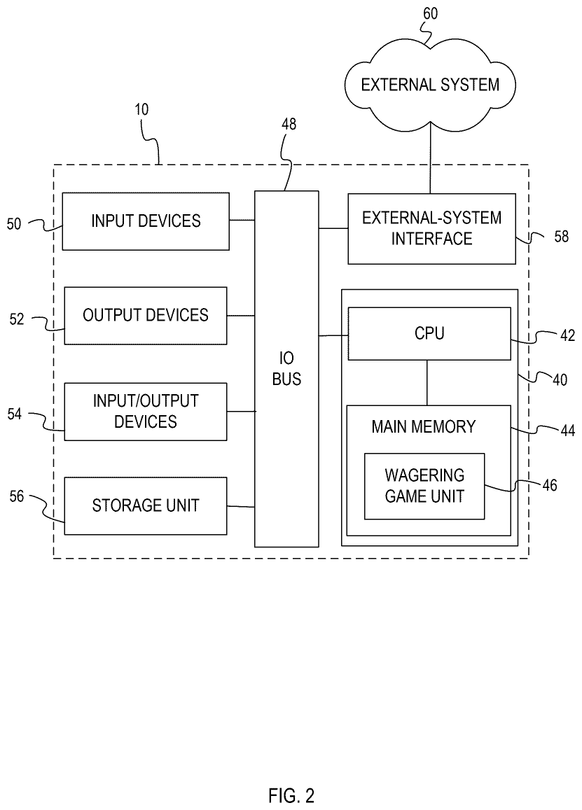

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S. A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

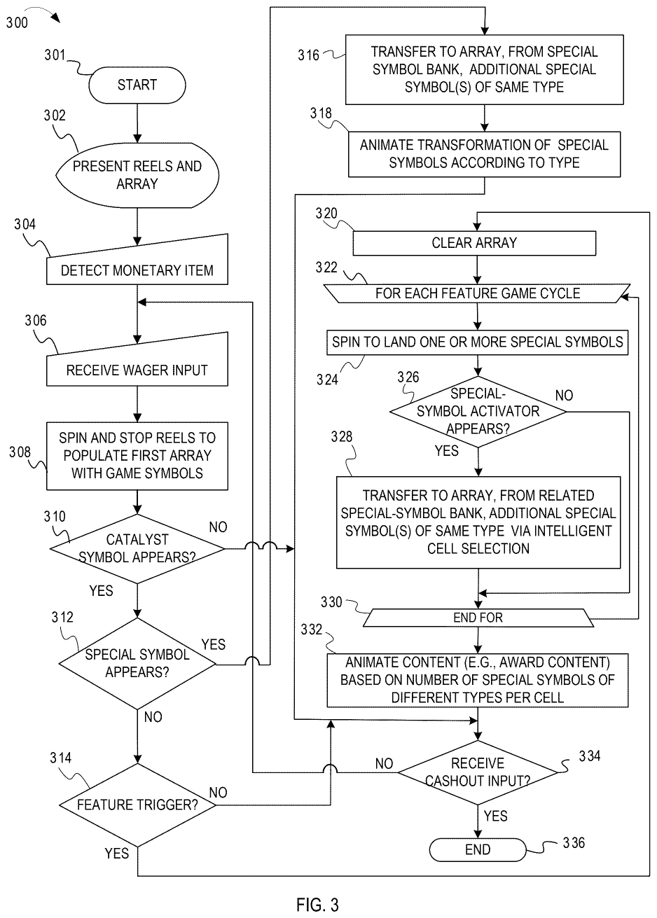

Referring now to FIG. 3, there is shown a flowchart representing one data processing method corresponding to at least some instructions stored and executed by the game-logic circuitry 40 in FIG. 2 to perform operations according to an embodiment of the present disclosure. The data processing method is described below in connection with an exemplary representation of a series of game cycles (including presentation of the game cycle/spin outcomes) in FIGS. 4-12. The description of FIG. 3 refers to “game-logic circuitry” which may utilize a single processor or a set of a plurality of processors that performs operations associated with the flow 300. The set of processors may operate in conjunction with each other and may be distributed across various networked devices (e.g., across a network). The types of processors may include a central processing unit, a graphics processing unit, any combination of processors, etc.

The data processing method follows a flow 300, which commences at processing block 301. The flow 300 continues at processing block 302, where game-logic circuitry controls one or more presentation devices (e.g., mechanical-reel display device, video display device, or a combination thereof) that presents one or more pluralities of symbol-bearing reels and an array of symbol positions. The presentation associated with the method described herein may be performed by a presentation assembly including one presentation device or more than one presentation device. The symbol positions the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position.

It should be noted that although this present description refers to one type of secondary game award or objective (i.e., a jackpot or credit awards), other embodiments can utilize different types of secondary game awards or objectives, such as cash, fixed prize awards, game play awards (e.g., a number of free spins, a picking game, a wheel spin), etc. Hence, in one embodiment, the symbol or object used to indicate the description or value of the secondary game award may be referred to generically as an award symbol. In some embodiments, the award symbols may include value-bearing symbols (e.g., credit values presented on a special symbol). In one example, a value-bearing symbol is associated with a credit or currency value indicated on the symbol itself. The value on a particular value-bearing symbol may be fixed or variable (e.g., random) from one game cycle to the next.

Returning to FIG. 3, after processing block 302, the flow 300 continues at processing block 304, where the game-logic circuitry detects, via a value input device, a physical item associated with a monetary value that establishes a credit balance. As shown in FIGS. 4-12, the credit balance may be shown on the credit meter 200 of the gaming machine. Furthermore, win amounts for a game event (e.g., a primary-game event, a secondary-game event, etc.), can be presented in a win meter 204.

The flow 300 continues at processing block 306, where the game-logic circuitry initiates a wagering game cycle in response to an input indicative of a wager covered by the credit balance. To initiate a spin of the reels, the player may press a “Spin” or “Max Bet” key on a button panel or touch screen. As shown in FIGS. 4-12, the wager may be shown on a bet meter 202.

The flow 300 continues, at processing block 308, where, using an RNG, the game-logic circuitry spins and stops the reels to randomly land symbols on a reel set in visual association with one or more paylines (also known as lines, ways, patterns, or arrangements). The reel spins may be animated on a video display by depicting symbol-bearing strips moving vertically across the display and synchronously updating the symbols visible on each strip as the strip moves across the display. The reel spin may land any of a variety of types of symbols (e.g., standard symbols, a catalyst symbol, any one of a plurality of types of special symbols, trigger symbols,, etc.). As shown in FIG. 4, at least a portion of a presentation assembly (e.g., presentation device(s) 400) presents (on a primary presentation section 420 or on a primary display) array 230, such as a three-by-five array comprising three rows 220, 222, and 224 and five columns 210, 212, 214, 216, 218. Each column is associated with a respective reel such that the reel populates the three symbol positions in the associated column. The reels associated with the array 230 may be referred to herein as the reel set. The reels bear a plurality of symbols. In one embodiment, the plurality of symbols includes standard symbols (e.g., A, B, C, D, E, and F). In one embodiment, the plurality of symbols also includes a plurality of types of special symbols. In one example, special symbols are of distinct types or classifications of items, but with a common theme that relates the special symbols (e.g., a first type of special item symbol (e.g., a marshmallow-type special symbol), a second type of special symbol different from the first type (e.g., a chocolate-type special symbol), and a third type of special symbol different from either the first or second types of special symbols (e.g., a graham-cracker-type special symbol), which are examples of elements of a food-themed game for s'mores). The catalyst symbol, standard symbols, and special symbols are used during primary-game play rounds (e.g., during spins, post-spin but prior to next game-play round, etc.) to determine outcomes of the primary game (also referred to as the base game).

Referring again to FIG. 3, at processing block 310, the game-logic circuitry determines whether a catalyst symbol appears. For example, as illustrated in FIG. 4, a catalyst symbol 441 randomly appears within a designated cell (e.g., within trigger cell 440 designated only for random appearances of the catalyst symbol 441 during the base game or for random appearances of special-symbol activators during a particular feature). The catalyst symbol can represent a catalyst item (e.g., fire, heat, etc.) that would cause transformation in a physical-world correlate associated with the common theme of the special symbols (e.g., a fire catalyst causes transformation by cooking food-themed components, an ice catalyst causes transformation by freezing liquid-themed components, etc.). In one embodiment, the catalyst symbol can appear as an outcome of a spin (e.g., appears in the designated cell of the array as an immediate result of reel-spin event), whereas in other embodiments, the catalyst symbol can appear based on an agent action that follows a spin-event (e.g., a bear character or campfire object throws fire onto the designated cell after the spin occurs, but prior to the game-logic circuitry completing the game-play round).

Referring back to FIG. 3, if no catalyst symbol appears, then the flow 300 continues at processing block 334. However, if, at processing block 310, a catalyst symbol does appear, then the flow 300 continues at processing block 312, where the game-logic circuitry determines whether a special symbol randomly appears in the array as a result of the base game spin and RNG outcome. For example, as shown in FIG. 4, the game-logic circuitry determines that special symbol 481 randomly appeared during a base game spin. In one embodiment, only one type of special symbol appears during a single spin of the base game. In another embodiment, multiple types of special symbols can randomly appear during a single spin of the base game.

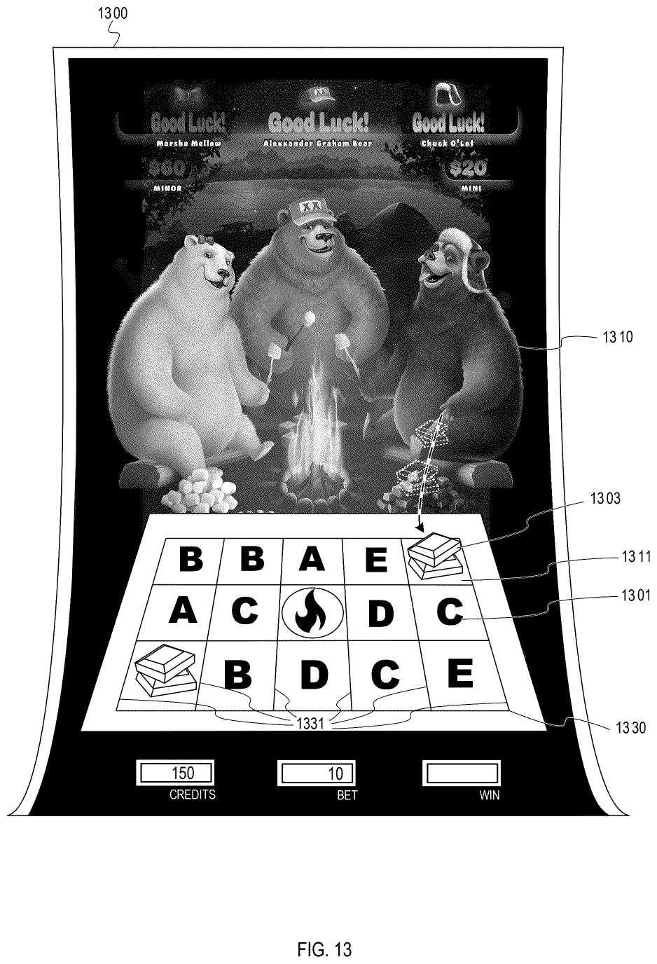

If, at processing block 312, a special symbol has appeared, then the flow 300 continues at processing block 316 where the game-logic circuitry transfers, to the array from a special-symbol symbol bank, additional special symbol(s) of the same type that appeared. Special symbols can be randomly transferred (e.g., throw, shot, dropped, etc.) to and positioned on (e.g., superimposed over, inserted into, added to, combined with, etc.) the array via access to a special-symbol bank presented via a separate portion of the same display than the game array or presented on a secondary display. A special-symbol bank may also be referred to as reverse pot (e.g., an already filled pot that randomly provides valuable items instead of collecting them) or other types of groupings (e.g., inventories, piles, bundles, etc. ,) where each is of a different type. The game-logic circuitry depicts special-symbol banks as a resource of the respective type of special symbol that will be randomly provided from outside of the array (e.g., dropped vertically from above a top border of the array, shot horizontally from beyond a side border of the array, inserted upward from below the array, etc.). In some embodiments, the game-logic circuitry does not illustrate the special symbols inside of the special-symbol bank as the special symbols can be associated with the special-symbol bank via a description, visual effect, etc. described or depicted elsewhere (e.g., in an icon or other identifier on the side of the special-symbol bank, in an icon or graphic associated with a particular special-symbol activator or agent depicted as a special-symbol bank controller, in a pay table description, etc.). One example is illustrated in FIG. 4, where each of three special-symbol banks 470, 480, and 490 are presented. Each depicts a respective special-symbol icon (e.g., special-symbol icons 411, 412, and 413 associated, respectively, with special-symbol banks 470, 480, and 481). Another example is illustrated in FIG. 13, where piles of special symbols (e.g., piles of marshmallow-type graphics, graham-cracker-type graphics, and chocolate-type graphics) are associated relatively with distinctive bear characters which each throw their respective type of special symbol onto array 1330.

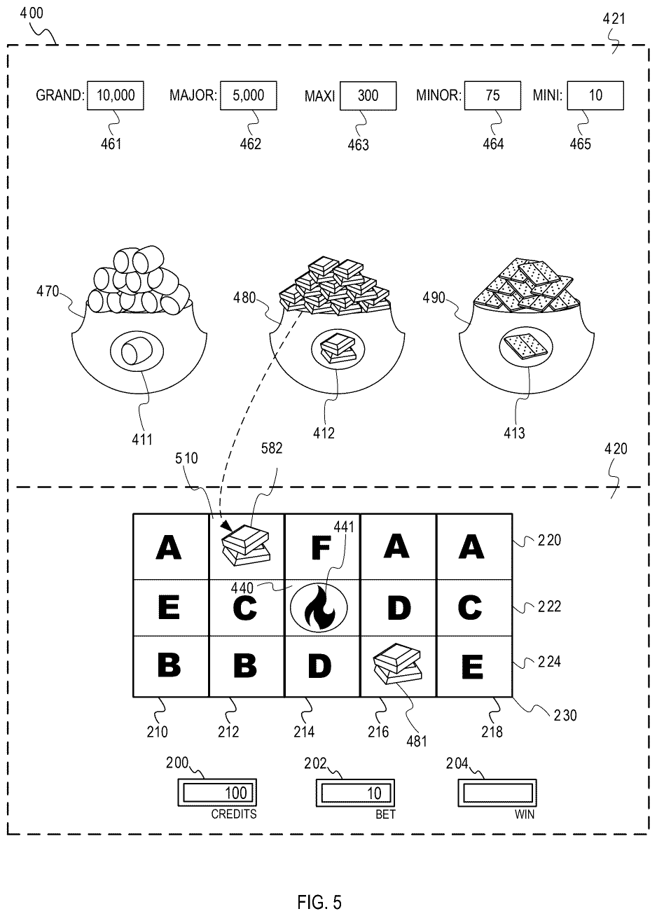

In one embodiment, special symbols are provided by the special-symbol bank depending on a type of special symbol that was randomly presented when the reels spun (during base game play). For example, in one embodiment, if, during a base game spin, one of the special symbols appears in the array, then the corresponding special-symbol bank of that type is activated to provide additional special symbols before completing the game play for the base game cycle. In one embodiment, multiple types of special symbols may appear in the array during a reel spin of a base-game cycle, causing multiple special-symbol banks to activate and provide additional special symbols to the array during the base-game cycle. As shown in FIG. 5, because the special symbol 481 appeared during the spin of the reel-set, only the special-symbol bank 480 adds an additional special symbol (i.e., special symbol 582) and overlays it (to replace) the standard symbol that was in cell 510.

The special-symbol banks can further be associated (e.g. thematically) with different agents (e.g., three distinct looking bears-a black bear, a brown bear, and a white bear) which are each presented as distinct respective GUI objects (e.g., actors, controllers, bankers, characters, etc.) that provide (e.g., throw, shoot, drop, add, insert etc.) their corresponding special symbol to the array (e.g., see FIG. 13, showing agent 1310 throwing the special symbol 1303 onto the array 1330 to overlay a standard symbol that previously had landed in cell 1311). Agents can be associated with a particular symbol (“agent symbol”) that appears within the trigger cell 440 (e.g., during series of feature game cycles). Agent symbols have the appearance of their respective agent (e.g., a first bear symbol specifies a black-bear character-which is associated with chocolate-type special symbol, a second bear symbol specifies a brown-bear character-which is associated with a graham-cracker-type special symbol, a third bear symbol specifies a white-bear character which is associated with a marshmallow-type special symbol).

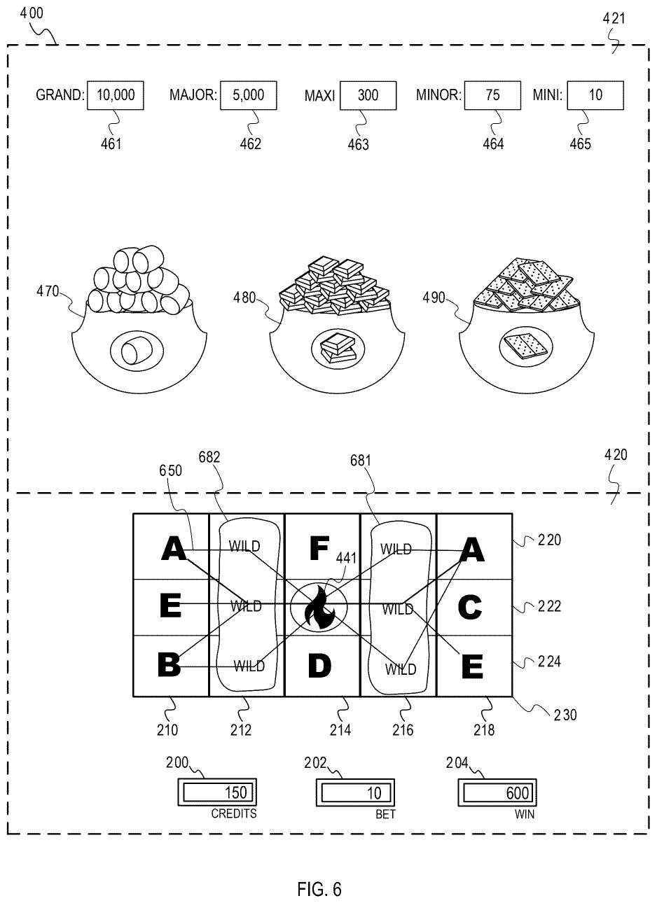

Referring again to FIG. 3, in response to processing block 315, the flow 300 continues at processing block 318, where the game-logic circuitry animates transformation of any special symbol presented according to special-symbol type. The game-logic circuitry (in response to appearance of the catalyst symbol) transforms the appearance of (e.g., changes, modifies, combines, etc. the appearance of) any special symbols based on the theme (e.g. fire-type catalyst symbol catalyzes melting of a chocolate-type special symbol revealing wild reels (e.g., wild reels 682 and 681 depicted in FIG. 6), fire-type catalyst symbol catalyzes toasting of a second type of special symbol (e.g., marshmallow-type special symbol) revealing credit prizes, fire-type catalyst symbol catalyzes crumbling of a third type of special symbol (e.g., graham-cracker-type special symbol) revealing a high-symbol (i.e., converts into additional instances of the highest ranking standard symbol currently presented on the array or the highest ranking standard symbol in a pay table)). In one embodiment, if multiple special symbols appear in the array (and/or are transferred to the array), the respective presentations and/or transformations can be related, can affect each other, etc. For example, a chocolate-type special symbol may melt into WILD symbols, whereas a marshmallow-type special symbol, concurrently presented in the array, may transform into a modifier (e.g., a multiplier) for the WILD symbols. In another embodiment, a chocolate-type special symbol may combine with a marshmallow-type special symbol to create a combined symbol (e.g., a chocolate covered marshmallow) having a different transformation effect related to the combination. In one embodiment, the catalyst symbol is considered a WILD symbol for purposes of determination of base game outcomes. Furthermore, in some embodiments, any of the special symbols that were added or transformed may be indicated as a three-dimensional version of the added or transformed symbol. In some embodiments, the system utilizes 3-D images to indicate line wins or other important relationships between different items presented. As illustrated in FIG. 6 payline graphics 650 link together winning symbols. However, in other embodiments, instead of payline graphics 650, the game-logic circuitry can instead cause symbols that are in a winning line to pop-up out of the plane of the array 230 and appear as 3-D type symbols. During a celebratory effect, the game-logic circuitry can cycle through various line wins by popping up only those symbols which contribute to the particular line win being highlighted.

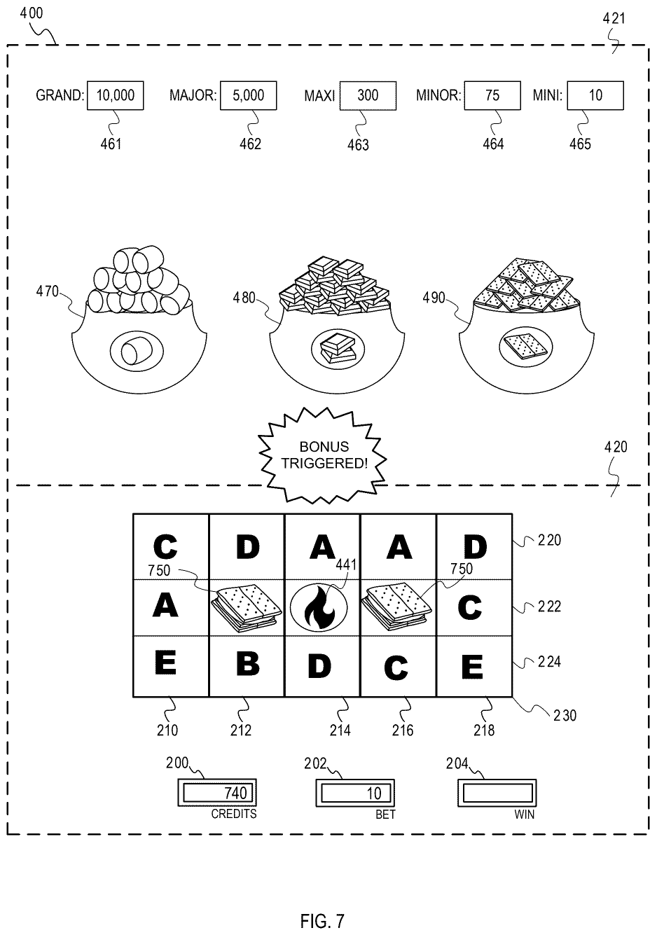

If, at processing block 312, a special symbol has not appeared, then the flow 300 continues at processing block 314 where the game-logic circuitry determines whether a particular feature is triggered. For example, during a primary game, or during a secondary game, a series of feature game cycles can be triggered. In one embodiment, appearance of one or more trigger symbols (e.g., “feature-trigger” symbols or “bonus-trigger” symbols) randomly appear in the array, which triggers the series of feature game cycles (e.g., to trigger “bonus-feature cycles” or “bonus-game cycles”). In one embodiment, the trigger includes a random appearance of a given number of feature-trigger symbols and concurrent appearance of the catalyst symbol. For example, as shown in FIG. 7, feature-trigger symbols 750 (e.g., two s'more symbols) are presented, along with the catalyst symbol 441, to trigger the feature. In one example, by using feature-trigger symbols (which are separate from the special symbols), then no seeding of the feature occurs. For example, in one embodiment, no special symbols persist from a base game into the feature, thus allowing for more symbols to be added during feature game cycles (thus leading to a more active feature). Furthermore, in one embodiment where multiple types of special symbols can be added to the array during a single spin of the base game, after transference of all of the types of special symbols to a single cell of the array, the game-logic circuitry can combine the individual special symbols in that cell and transform them into a feature-trigger symbol, which can contribute to the number of feature-trigger symbols required to trigger the feature.

Referring again to FIG. 3, if, at processing block 314 the feature is not triggered, then the flow 300 continues to processing block 334. If, however, at processing block 314, the feature is triggered, then the flow 300 continues at processing block 320, where the game-logic circuitry clears the array, and at processing block 322, a loop occurs for the series of feature game cycles ending at processing block 330 (i.e., when a feature-cycle counter counts down to zero or reaches a number threshold). In one embodiment, prior to beginning the loop, the game-logic circuitry can randomly select one or more of the banks as a pot from which to initially add special symbols to the cleared array. In one embodiment, during the feature, only the plurality of types of special symbols and special-symbol trigger symbols (e.g., also referred to herein as special-symbol activators and/or agent symbols) can appear in the array (i.e., no standard symbols). In response to the trigger occurring, the objective of the feature is to collect (and combine) one of each of the different types of special symbols into any given cell of the array (e.g., each cell in the array can hold up to the total number of types of special symbols-e.g., three types of bonus symbols). The special symbols can be thematically combinable into a combined item (e.g., three different ingredients to combine into a given food item (e.g., chocolate, marshmallow, and graham cracker combines into a s'more), three different chemicals to combine into a given potion, etc.). The combined item (e.g., also referred to in one example as a bonus item) has a greatest award value. Cells with fewer than the total number of types of special symbols (e.g., fewer than three types of special symbols-e.g., one or two special symbols) can receive lower award values.

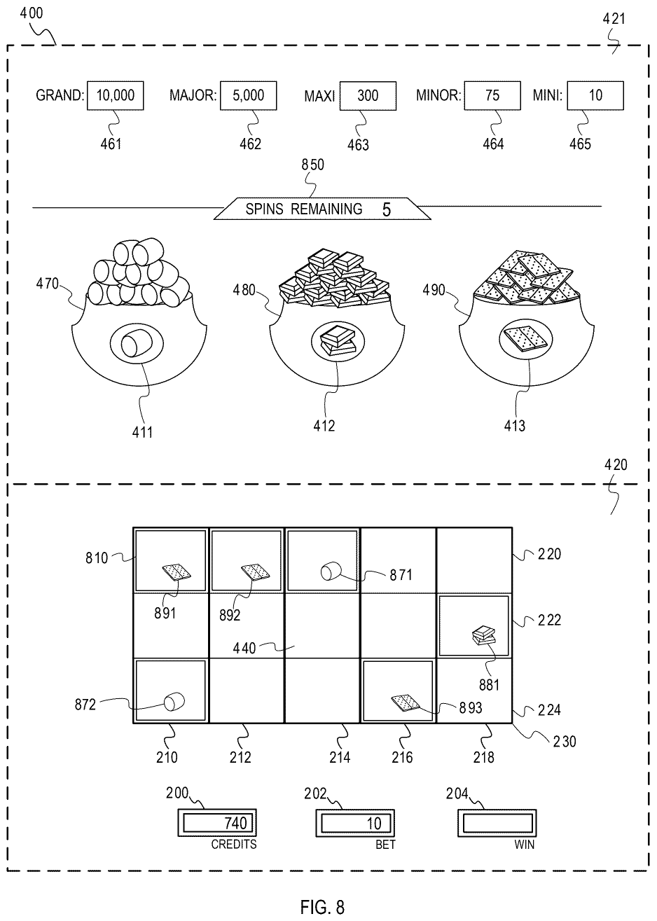

Referring again to FIG. 3, at processing block 324, the game-logic circuitry spins the reels to land, for each spin, one or more special symbols from the distinct types of special symbols. For instance, in one embodiment, during the feature the reel set is configured to present only the plurality of distinct types of special symbols. As shown in FIG. 8, in response to a spin of the reel set during a first feature game cycle, special symbols 871, 872, 881, 891, 892, and 893 randomly appear in the array 230. As special symbols get added to each cell, the cell characteristics change accordingly to present a cell occupancy highlight effect which indicates a number of the types of special symbols that occupy the cell as the cell fills up during the feature (e.g., the cell changes different background colors or uses different highlight effects, the cell uses a different number or type of border graphics 810, the cell changes font types or sizes, etc.).

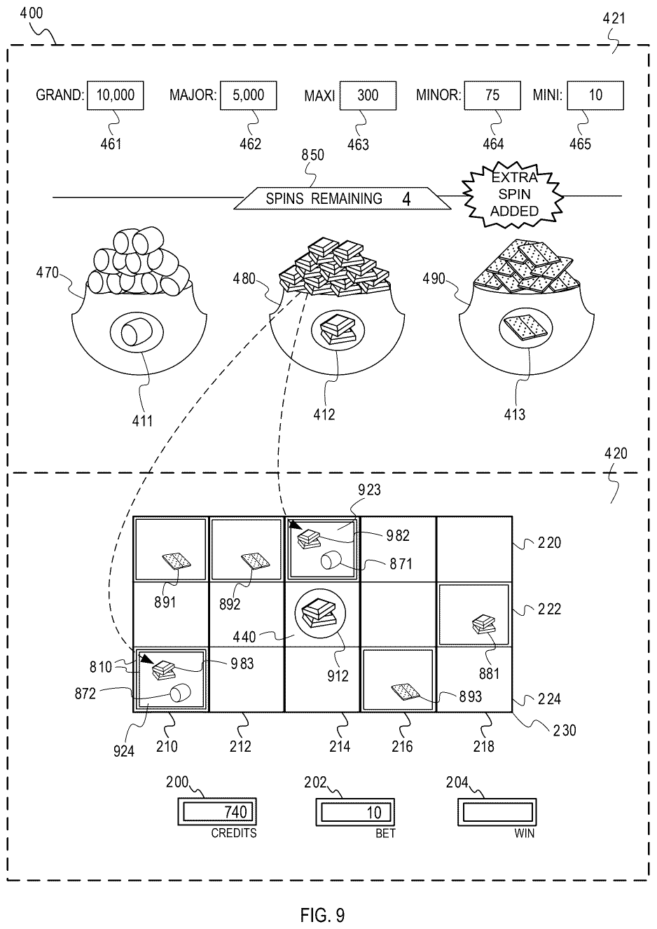

Referring again to FIG. 3, at processing block 326 the game-logic circuitry determines whether a special-symbol activator appears randomly within the trigger cell. If, at processing block 326, the game-logic circuitry determines that a special-symbol activator does not appear during a feature game cycle, then the flow continues to processing block 330, where the game-logic circuitry either returns to the start of the loop at processing block 322 for an additional one of the series of feature game cycles (e.g., if the feature-cycle counter has not reached the ending threshold), or ends the loop if the series of feature game cycles has reached the ending threshold. For example, in FIG. 8, during the first feature game cycle, the game-logic circuitry determines that no special-symbol activator (e.g., no special-symbol icon, no agent symbol, etc.) appears in the trigger cell 440. The game-logic circuitry further verifies whether feature-cycle counter 850 (“spin counter”) has counted down (e.g., the feature-cycle counter 850 had not yet reached zero). Consequently, game-logic circuitry determines that additional feature game cycles remain, and the game-logic circuitry initiates a second feature game cycle shown in FIG. 9. As shown in FIG. 9, during the second feature game cycle, after spinning the reels (which resulted in no additional special symbols landing in the array 230), the game-logic circuitry determines that special-symbol activator 412 (associated with a chocolate-type special symbol) appears in trigger cell 440.

Referring again to FIG. 3, if at processing block 326 the game-logic circuitry determines that the special-symbol activator appears, then the flow 300 continues at processing block 328 where the game-logic circuitry transfers to the array, from a related special-symbol bank, additional special symbol(s) of a same type via intelligent cell selection. If a special-symbol activator (e.g., a special-symbol icon, an agent symbol, etc.) randomly appears in the trigger cell during a feature game cycle, depending on the type of special-symbol activator, the game-logic circuitry causes the corresponding special-symbol bank (or corresponding agent) associated with the particular special-symbol activator to transfer (e.g., drop, throw, shoot, etc.) a given number (e.g., from one to three) of additional ones of the respective special symbol to the game array. Furthermore, any additional special symbol(s) transferred to the array are added intelligently to specifically selected cell(s) (intelligent selection) so as to place the additional special symbol(s) in the most beneficial locations on the array. In other words, because the special symbols are of different types that are configured to be combined to make a combined item of highest-tier award potential (e.g., to make a s'more item), then, in one embodiment, the game-logic circuitry transfers a special symbol of one type to a cell that is closest to already forming the combined item, such as selecting (for transfer of the additional special symbol) a cell that contains the highest number of the other types of special symbols, yet which is not yet full (e.g., adds to cell with the least vacancy in order to be completed). In other words, if a special symbol of a first type appears in the trigger cell, then when a special symbol of the first type is transferred to the array, it is added to a cell that already has one of the other types of special symbols so that each special symbol added will add to a cell that already has another type of item in it instead of being positioned into an empty cell. For example, as shown in FIG. 9 the game-logic circuitry causes the special-symbol bank 480 to transfer special symbols 982 and 983 to respective cells 923 and 924 of the array 230. Because special-symbol activator 912 appeared in trigger cell 440, then instances of the type of special symbol (e.g., chocolate-type special symbol 982 and chocolate-type special symbol 983) are transferred from the special-symbol bank 480 to the respective cells 923 and 924 of the cells in the array 230 that already contains an item of a different type (e.g., the game-logic circuitry intelligently selects, for placement of chocolate-type special symbols 982 and 983, the respective cells 923 and 924, which already contain marshmallow-type special symbols 871 and 872). The game-logic could also have intelligently selected and placed the chocolate-type special symbols 982 and 983 in respective cells that contain any of the graham-cracker-type special symbols 892, 892, or 893 as those cells also do not contain chocolate-type special symbols yet. Furthermore, in some embodiments, the game-logic circuitry animates content according to the cell occupancy highlight effect. For example, a cell occupancy highlight effect changes for the cells 923 and 924 in which the chocolate-type special symbols 982 and 983 were placed (e.g., the number of border graphics 810 increases to two for the cells 923 and 924 to indicate that the they now contain two special symbols of different types).

In one embodiment, if three symbols or more randomly appear in a single feature game cycle, the feature-cycle counter 850 can increment a spin count (i.e., increment the feature-cycle count so that extra game cycles are added). The special-symbol activator 912 is considered a symbol for purposes of increasing the spin count.

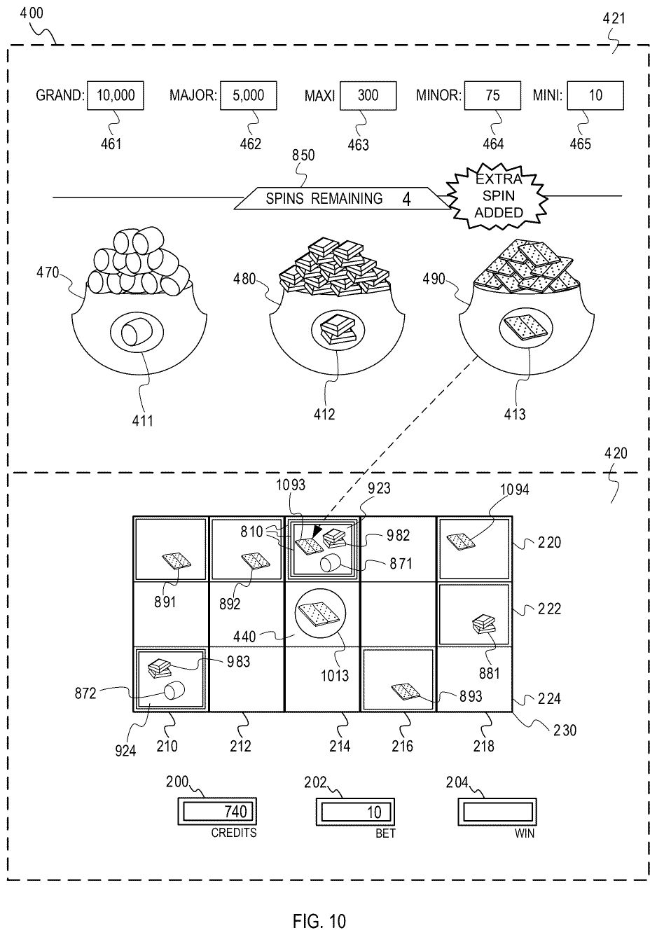

FIG. 10 illustrates an example of a third feature game cycle where special-symbol activator 1013 appears randomly within the trigger cell 440. The special-symbol activator 1013 corresponds to the special-symbol bank 490. The game-logic circuitry causes special-symbol bank 490 to transfer special symbol 1093 to the array 230. The game-logic circuitry places, via intelligent selection, the special symbol 1093 in a cell that already contains other types of special symbols, such as the cell 923, which already contains two of the other types of special symbols (special symbols 871 and 982). The game-logic circuitry also causes the occupancy highlight effect to change for cell 923 (e.g., cell 923 now has three border graphics 810 to indicate that the cell contains three types of special symbols).

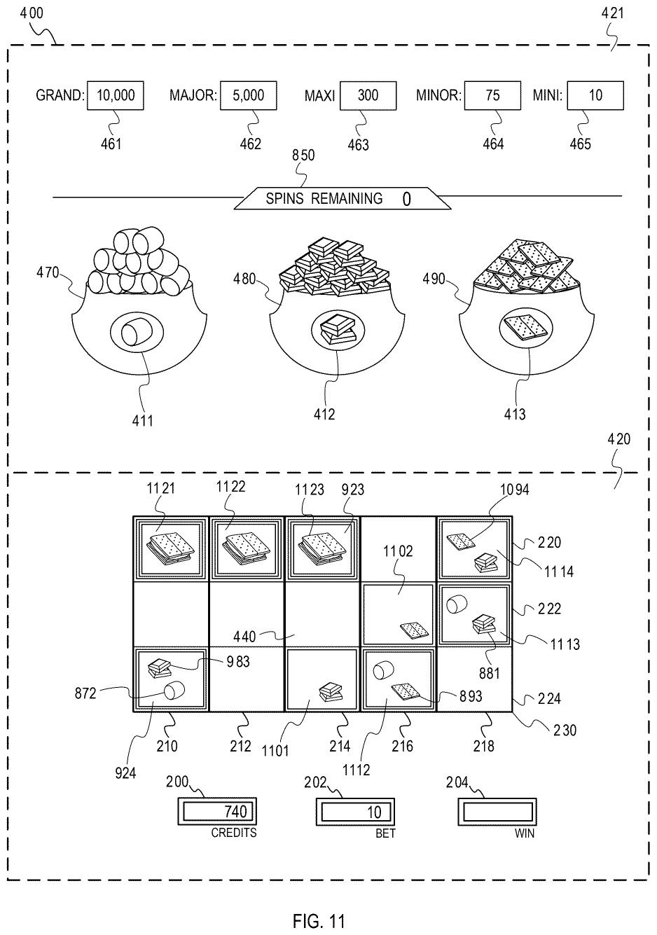

When a final special symbol required to fill a cell enters the cell (or afterwards, such as during an award portion of the feature after the feature game cycles have completed), the cell can appear to activate (e.g., turn on fire or perform other action based on theme) and transform into a combined item (e.g., transforms the three special symbols in the cell into a single s'more object having a high-tier payout). For example, as shown in FIG. 11, the game-logic circuitry causes the special symbols 982, 871, and 1093 in cell 923 to merge and transform into combined item 1123 (depicted as a s'more object). When a first combined item occurs (e.g., when three special symbols occupy a single cell), the game-logic circuitry causes the gaming machine to perform special effects (e.g., sounds, lighting, etc.), such as changing (e.g., increasing in activity) the content in the secondary presentation section 421 (or on a secondary display) and/or on other presentation devices or special effects hardware, such as causing emotive lighting on the gaming machine to turn on, increase in intensity, change patterns, combinations thereof, etc. Thus, the completion of a combined item (e.g., the completion of a s'more) indicates a higher reward for the feature, thus the change of the special effects (e.g., increase in volume, increase in lighting effects, etc.) indicates a corresponding increase in potential for a high payout of the feature (as combined items payout according to highest level of award tiers). As further illustrated in FIG. 11, the feature game cycles have been completed and the cells 1121, 1122, and 923 each obtained three unusual types of special symbols, hence the game-logic circuitry transforms their respective symbols into an instance of combined item 1123. Cells 1112, 1113, 1114, and 924 each obtain two unusual types of special symbols. Furthermore, cells 1101 and 1102 only obtained one special symbol each.

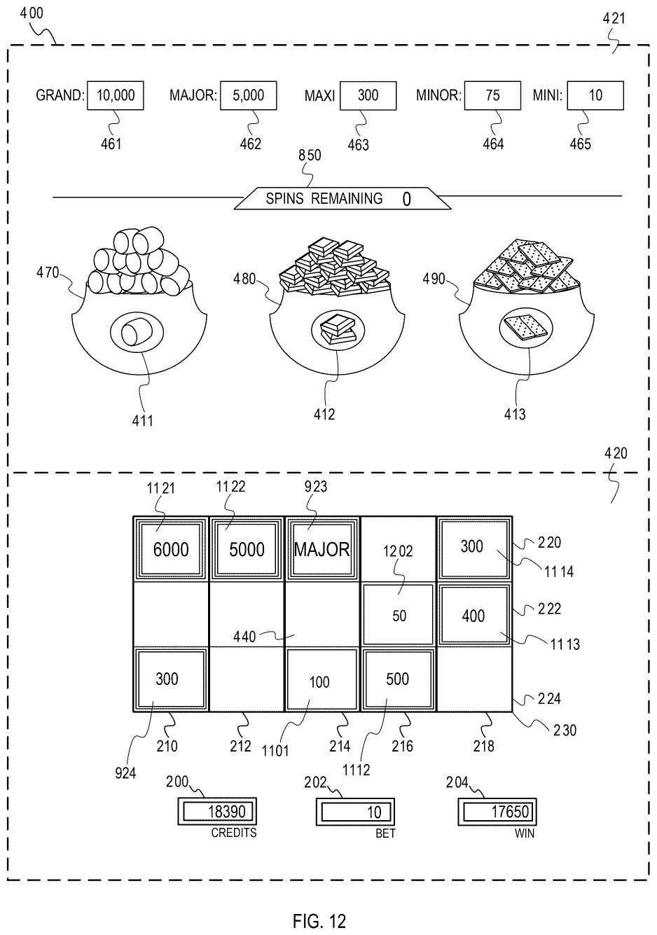

Referring again to FIG. 3, after the feature game cycles have concluded, then at processing block 332, the game-logic circuitry animates content for the feature based on a number of special symbols of distinct types that appear in each cell. For example, as shown in FIG. 12, the game-logic circuitry converts the groupings of specials symbols and/or combined items for occupied cells (e.g., cells 923, 924, 1101, 1112, 1113, 1114, 1121, and 1122) into award objects represented as credit values and/or as jackpot bonus indicators (e.g., of values indicated in progressive jackpot meters 461, 462, 463, 464, or 465). As the game-logic circuitry reveals award object values on the array 230, the award object values may appear in various levels. For example, cells with only one item are in a first award tier (providing a low range of award values, e.g., 50-300), cells with two items are a second award tier (providing a mid-range of award values, e.g., 350-900), and cells with three items are in a third award tier (providing a high range of award values, e.g., 1000-10000). In some embodiments, the award object value may have an intermediary stage (e.g., an additional symbol) that appears where a jackpot amount (or other additional award) may appear. For example, the cell 923 may first present an intermediary symbol (e.g., a “Yield” symbol), which, thereafter, transforms to one or more progressive jackpot symbols (e.g., the “Major” jackpot shown in cell 923, multiple “Mini” jackpots, a “Mini” and a “Minor,” a “Double Minor,” etc.). In some embodiments, the feature can also award (e.g., at the intermediary stage) a retrigger of the feature (e.g., a retrigger of the series of feature game cycles). In some embodiments, the game-logic circuitry presents award object values in font sizes that correspond to the cell occupancy highlight effect of each given cell (e.g., small font size for first reward tier, medium font size for second reward tier, large font size for third reward tier).

Referring again to FIG. 3, after conducting the feature (or at other points in flow 300 discussed previously), the flow 300 proceeds to processing block 334, wherein the game-logic circuitry determines whether a cashout input has been received. If a cashout input is received, then the flow 300 ends at processing block 336. If a cashout input is not received, the flow 300 returns to processing block 306 to await an additional wager input for the base game.

In some examples describes herein, the array is a rectangular array. In other embodiments, however, the array is a skewed array, such as the skewed array 1330 shown in FIG. 13. The skewed array 1330 is a visual effect that causes the upper portion of the skewed array 1330 to appear to extend toward the special-symbol banks (e.g., the piles of marshmallow-type special symbols, graham-cracker-type special symbols, or chocolate-type special symbols that appear along with the distinct agent (e.g., “bear”) that throw the special symbols onto the skewed array 1330 from the background of the content presented via display 1300). In some embodiments, the skewed array 1330 has a perspective that matches or substantially adheres to the perspective presented in the imagery of the background content as would be viewed from a perspective of a user positioned (e.g., seated) at a gaming machine (e.g., horizontal lines 1331 of the skewed array 1330 taper and converge toward a vanishing point of a horizon line of the background content). Thus, the skewing creates a visual effect that the skewed array 1330 seems to three-dimensionally blend into, or be incorporated with, the background scene (e.g., the skewed array 1330 may be depicted as a picnic blanket for a campfire scene in which certain agents (e.g., the bears) are making s'mores around a campfire). In some embodiments, prior to the agent performing an action, the game-logic circuitry can cause the background content (showing the agent) to zoom in, thus creating a focus on the agent in relationship to the skewed array. In one embodiment, the zooming maintains the perspective of the skewed array relative to the perspective of the background imagery. When the agent completes the action related to the game (e.g., after the bear throws all of the special symbols to the array for the game-play round or cycle), then the background content returns (e.g., zooms back out) to a default appearance. In some embodiments, in response to player input associated with an agent, the game-logic circuitry can cause an attribute of the agent to change or can cause the agent to perform an action, such as an attribute or action that is not related to a game outcome (e.g., a player input touches a bear, which causes the bear to giggle, a player changes an outfit of the agent, etc.). In one example, the background content, including the agents, is associated with a different virtual camera (e.g., a 3D model camera) as that for the skewed array, thus permitting the background to zoom relative to the skewed array while permitting the skewed array to maintain the same size, position, etc.

Some embodiments include skewed arrays according to various types of perspectives (e.g., parallel, oblique, aerial, counterpoint) depending on a scene presented in the background content. Some embodiments may automatically adapt skewing of the array based on a change to background content perspective, or vice versa, to adapt elements of background art to match skewed characteristics of the array. For example, the gaming system can include an option to manually select different background scenes or themes via user input (e.g., via player, via operator, etc.). In response, the gaming system can adapt the foreground content accordingly (e.g., automatically skew array lines to substantially match the background perspective elements and in turn automatically modify a position or appearance of game content to adapt to the background). In another example, the gaming system can include an option to cause background content to automatically adapt to the perspective of an already skewed array shape (e.g., modify background art automatically, via use of a generative machine learning model, to modify a horizon line accordingly for the background-art scenery).

In one embodiment, some symbols (e.g., symbols that appear during a spin of the base game) may appear as flat relative to the dimensions of the skewed array 1330. Other symbols, (e.g., special symbols, trigger symbols, added high symbols, etc.) can appear with various special effects, such as via presentation with a depth or stereoscopic effect (e.g., via true-3D, via 3D shading, etc.), such as symbol 1303. For example, landed symbols can at first be presented as flat symbols, and if the symbol appears in a payline or for other important events, the symbol can transform from flat into a true-3D appearance (e.g., not flat relative to the plane of the array 1330, but popped-up as a 3D representation of the symbol). In some embodiments, the 3D effects are pronounced because of the skewed effect of the array. For example, if the array is skewed, then the 3D effect can flip upward (e.g., rotate upward) off of the 2D plane into the 3D effect.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the secondary being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence. For example, in one embodiment (e.g., as shown in FIG. 3), the flow 300 is illustrated such that game-logic circuitry determines makes three determinations respectively at processing blocks 310, 312, and 314 where the first depicted determination is whether a catalyst symbol appears (at processing block 310), the second depicted determination is whether a special symbol appears (at processing block 312), and the third depicted determination is whether the feature is triggered (at processing block 314). However, in other embodiments, the operations at processing blocks 312 or 314 can be performed concurrently (or in different order) as the determination as to whether to proceed to processing block 316 or whether to proceed to processing block 320 depends on whether either a special symbol appears (312) or the trigger occurs (314).

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A gaming system comprising:
a computer memory;
a presentation assembly; and
a processor communicatively connected to the computer memory and the presentation assembly, wherein the processor is configured to execute instructions, which when executed cause the gaming system to perform operations to:
present, via generation of presentation data and storage of the data in the computer memory, a plurality of special-symbol banks, wherein each of the plurality of special-symbol banks corresponds to a different one of a plurality of types of special symbols;
present a plurality of reels and an array, the plurality of reels bearing a plurality of symbols, the plurality of symbols including the plurality of types of special symbols, and a plurality of special-symbol activators, wherein each of the plurality of special-symbol activators corresponds to a different respective one of the plurality of types of special symbols;
conduct, in response to a trigger event, a series of game cycles, wherein each of the series of game cycles includes operations to:
spin and stop the plurality of reels to land one or more of the plurality of types of special symbols in the array and to land a first special-symbol activator associated with a first of the plurality of special-symbol banks;
transfer to the array, from the first of the plurality of special-symbol banks in response to the first special-symbol activator landing, one or more special symbols of a first type of the plurality of types of special symbols, wherein the first type of the plurality of types of special symbols corresponds to the first special-symbol activator, wherein the transfer to the array of the one or more special symbols of the first type includes selection, for placement in the array, of at least one cell of the array that already includes a second type of the plurality of types of special symbols and not selection of any cell of the array that already includes any special symbol of the first type; and
animate, via the at least one cell of the array, content based on a number of special symbols in the at least one cell of the array.

2. The gaming system of claim 1, wherein the plurality of symbols further include a catalyst symbol and a set of trigger symbols, and wherein the processor is configured to execute additional instructions which cause the gaming system to perform additional operations to:
spin and stop the plurality of reels to land in the array, prior to the series of game cycles, the catalyst symbol and the set of trigger symbols; and
clear, in response to the plurality of reels landing the catalyst symbol and the set of trigger symbols, the array prior to conducting the series of game cycles.

3. The gaming system of claim 2, wherein one cell of the array is designated for either presentation of only the catalyst symbol prior to the series of game cycles, or presentation of the plurality of special-symbol activators during the series of game cycles.

4. The gaming system of claim 1, wherein the processor is configured to execute additional instructions which cause the gaming system to perform additional operations to:
animate, in response to transfer of the one or more special symbols of the first type, presentation of a cell occupancy highlight effect for the at least one cell of the array, wherein the cell occupancy highlight effect specifies a number of the plurality of types of special symbols that occupy the at least one cell.

5. The gaming system of claim 4, wherein the processor is configured to execute additional instructions which cause the gaming system to perform additional operations to:
animate the cell occupancy highlight effect for each given cell of the array containing at least one of the plurality of types of special symbols, wherein animating the cell occupancy highlight effect for each given cell comprises presenting one of a plurality of different visual effects based on a number of the plurality of types of special symbols that occupy each given cell.

6. The gaming system of claim 5, wherein the plurality of different visual effects includes at least one of different colors, different fonts sizes, or a different number of graphics.

7. The gaming system of claim 1, wherein each of the plurality of special-symbol banks includes a store of only the corresponding respective one of the plurality of types of special symbols.

8. The gaming system of claim 1, wherein each of the plurality of types of special symbols have a common thematic element that, when combined, transforms the plurality of types of special symbols into a themed item.

9. The gaming system of claim 1, wherein each of the plurality of special-symbol banks are associated with different agent objects that, via the presentation assembly, either, prior to the series of game cycles, initiate overlaying of only one of any one of the plurality of types of special symbols over one of the plurality of symbols already in a cell or, during the series of game cycles, present at most one of each of the plurality of types of special symbols per cell.

10. The gaming system of claim 1, wherein the array is a skewed array.

11. The gaming system of claim 10, wherein the skewed array has a skewed perspective that conforms to a perspective of background content in which the plurality of special-symbol banks are presented.

12. The gaming system of claim 11, wherein the processor is configured to execute additional instructions which cause the gaming system to taper horizonal lines of the skewed array to converge toward a vanishing point of a horizon of the background content.

13. A method of operating a gaming machine comprising:
presenting, by a processor via a presentation assembly in response to generation of presentation data and storage of the data in a computer memory, a plurality of special-symbol banks, wherein each of the plurality of special-symbol banks corresponds to a different one of a plurality of types of special symbols;
presenting a plurality of reels and an array, the plurality of reels bearing a plurality of symbols, the plurality of symbols including the plurality of types of special symbols, and a plurality of special-symbol activators, wherein each of the plurality of special-symbol activators corresponds to a different respective one of the plurality of types of special symbols; and
conducting, in response to a trigger event, a series of game cycles, wherein conducting each of the series of game cycles includes:
spinning and stopping the plurality of reels to land one or more of the plurality of types of special symbols in the array and landing a first special-symbol activator associated with a first of the plurality of special-symbol banks;
transferring to the array, from the first of the plurality of special-symbol banks in response to the first special-symbol activator landing, one or more special symbols of a first type of the plurality of types of special symbols, wherein the first type of the plurality of types of special symbols corresponds to the first special-symbol activator, wherein the transferring to the array of the one or more special symbols of the first type includes selecting, for placement in the array, at least one cell of the array that already includes a second type of the plurality of types of special symbols and not selecting any cell of the array that already includes any special symbol of the first type; and
animating, via the at least one cell of the array, content based on a number of special symbols in the at least one cell of the array.

14. The method of claim 13 further comprising:
animating, in response to transferring the one or more special symbols of the first type, a cell occupancy highlight effect for the at least one cell of the array, wherein the cell occupancy highlight effect specifies a number of the plurality of types of special symbols that occupy the at least one cell.

15. One or more non-transitory, machine readable mediums having instructions stored thereon, which when executed by a set of one or more processors cause a gaming machine to perform operations comprising:
presenting, by a presentation assembly of the gaming machine via generation of presentation data and storage of the data in a computer memory of the gaming machine communicatively connected to the presentation assembly, a plurality of special-symbol banks, wherein each of the plurality of special-symbol banks corresponds to a respective one of a plurality of types of special symbols;
presenting, via the presentation assembly, an array for a plurality of reels, the plurality of reels bearing a plurality of symbols, the plurality of symbols including standard symbols, a catalyst symbol, and the plurality of types of special symbols;
spinning and stopping, via the presentation assembly, the plurality of reels to land, based on a random number generator, symbols from the plurality of symbols in the array;
transferring to the array, via the presentation assembly in response to the array landing at least the catalyst symbol and a first special symbol of one of the plurality of types of special symbols, a second special symbol of the one of the plurality of types of special symbols from the one of the plurality of special-symbol banks that corresponds to the one of the plurality of types of special symbols; and
animating, via the presentation assembly in response to the transferring the second special symbol, a transformation of the first special symbol and the second special symbol via one of a plurality of transformation visual effects associated with the one of the plurality of types of special symbols.

16. The one or more non-transitory, machine readable mediums of claim 14, wherein the transferring to the array the second special symbol comprises executing, by the presentation assembly, an overlay visual effect that moves the second special symbol from the one of the plurality of special-symbol banks to overlay a standard symbol that already occupies a given cell of the array.

17. The one or more non-transitory, machine readable mediums of claim 14, wherein each of the plurality of transformation visual effects corresponds to a respective one of the plurality of types of special symbols, and wherein animating the transformation of the first special symbol and the second special symbol based on one of the plurality of transformation visual effects causes an appearance of the transformation to be different for the one of the plurality of types of special symbols than for other ones of the plurality of types of special symbols.

18. The one or more non-transitory, machine readable mediums of claim 14, wherein the animating the transformation of the first special symbol and the second special symbol based on the one of the plurality of transformation visual effects comprises transforming at least a portion of the first special symbol and the second special symbol into one of a group consisting of a wild symbol, a credit prize symbol, and a high symbol.
